(19) United States
(12) Patent Application Publication
(10) Pub. No.: US 2004/0231445 A1
(43) Pub. Date: Nov. 25, 2004

(54) Worm Drive System For Telesopes And LIDAR Systems

(75) Inventor: Michael Evan Marcus, Ellijay, GA (US)

Correspondence Address: MICHAEL MARCUS, 170 ACORN LANE, ELLIJAY, GA, 30540, US

(73) Assignee: Mr. Michael Evan Marcus, Ellijay, GA (US)

(21) Appl. No.: 10/709,558

(22) Filed: May 13, 2004

Related U.S. Application Data
(60) Provisional application No. 60/320,205, filed on May 19, 2003.

(51) Int. Cl. F16H 48/26

(52) U.S. Cl. 74/425

(57) ABSTRACT

An invention consisting of a worm drive system for astronomical telescopes, light detection and ranging (LIDAR) systems, and other implements which require precision in pointing, motion and tracking about an axis of revolution. The worm drive system consists of a plate assembly supporting in precise fashion: a hub assembly, a worm assembly and a motor assembly. The design and interaction of these assemblies makes the invention relatively immune to variations in ambient temperature during the operation of the invention, thereby preserving said precision during the operation of the invention. The hub assembly supports a worm gear, includes a simple method for attachment of the invention to the axis of revolution of the implement, and includes an adjustable clutch mechanism for the worm gear, with the clutch mechanism so designed as to maintain precise coaxial alignment of the worm gear axis relative to the hub assembly axis and therefore the axis of revolution of the implement. The worm assembly supports a worm and includes a pivot point, the entire worm assembly being balanced about the pivot point, thereby preserving precise alignment and coupling of the worm relative to the worm gear irrelative to all possible orientations of the invention which may occur during the invention's operation. The motor assembly supports a motor providing for axial rotation of the worm via, for example, a pair of pulleys and a belt, the purpose of the motor assembly being the prevention of the motor's torque, were the motor directly attached to the worm as is a common practice, from disturbing the precise alignment and coupling of the worm relative to the worm gear. The plate assembly includes a load block serving as a point of attachment for one end of a threaded rod, the other end of the threaded rod being attached to the implement, thereby precisely holding the plate assembly in a static position relative to the implement and the implement's axis of revolution, thereby allowing the axial rotation of the worm, via action of the motor, to precisely rotate the hub assembly and therefore the implement about the implement's axis of revolution.

### BACKGROUND OF THE INVENTION

There are many circumstances in the use of astronomical telescopes, light detection and ranging (LIDAR) systems and other implements where it is desirable or necessary to both point to and then track objects with extreme precision. Telescopes and LIDAR systems, for example, require extreme precision in both pointing and tracking accuracy. A lack of precision in pointing and tracking can result, for example, in a loss of time because it then becomes necessary to perform corrections to compensate for this lack of precision.

Various types of drive systems have been designed for telescopes, LIDAR systems, and other similar implements. These drive systems may have inherent design weaknesses which limit maximum obtainable precision, may be expensive to manufacture, or may be affected by changes in the ambient temperature during normal operation.

Worm drive systems are generally utilized for astronomical telescopes and LIDAR systems because such systems are relatively economical and easy to implement. The ideal worm drive system would be immune to the effects of ambient temperature fluctuations, would feature built in clutches that prevent damage to the drive system and/or the instrument without affecting the drive system's accuracy, would feature precise and stable adjustments for alignment of the worm to the gear, and would be completely free from gear backlash when the worm reverses direction. Such a system, theoretically, would be the ideal worm drive system. Therefore, the aim of the invention is the economical implementation of a worm drive system that overcomes the inherent design weaknesses normally found in such systems and approaches the theoretically ideal worm drive system as described.

### BRIEF SUMMARY OF THE INVENTION

To this end, the instrument of the invention is a mechanism providing for the precise pointing, motion and tracking of a telescope or other implement about an axis of revolution. The invention is comprised of a drive hub assembly, a drive worm assembly, a motor assembly, these said assemblies all being attached to a drive plate assembly. The invention may be directly attached to said implement's axis of revolution, or the invention may be attached to the axis of revolution of an intermediate apparatus, said apparatus providing additional gearing between the invention and said implement's axis of revolution, it being understood that said apparatus is specifically excluded from the invention.

The main advantages of the invention are that it is fairly simple and economical to manufacture, utilizes the minimal number of elements necessary to achieve a required degree of accuracy, maintains its accuracy extremely well throughout ambient temperature fluctuations, and provides for easy and precise adjustment of the invention's individual components.

### BRIEF DESCRIPTION OF THE DRAWINGS

FIG. 1 is an isometric perspective view of the invention.

FIG. 2 is a top plan view thereof.

FIG. 3 is a bottom plan view thereof.

FIG. 4 is a front plan view thereof.

FIG. 5 is a left plan view thereof.

FIG. 6 is a right plan view thereof.

FIG. 7 is an isometric perspective view of the hub assembly component of the invention, with the worm gear element removed for clarity.

FIG. 8 is an axial cross sectional of the hub assembly component of the invention.

FIG. 9 is an isometric perspective view of the worm assembly component of the invention.

FIG. 10 is a top plan view thereof.

FIG. 11 is an exploded perspective thereof, showing the individual elements of said worm assembly component.

FIG. 12 is an isometric perspective view of the motor assembly component of the invention.

FIG. 13 is an isometric perspective view of the plate assembly component of the invention.

FIG. 14 is an exploded isometric perspective view of the plate, worm and motor assembly components of the invention, the hub assembly component and the motor element of said motor assembly component having been omitted for clarity.

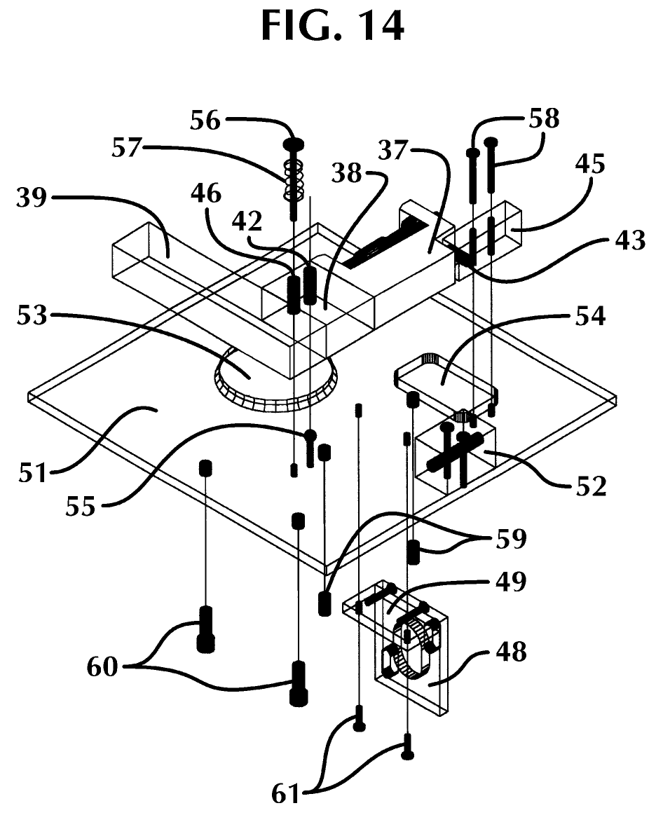

### DETAILED DESCRIPTION OF THE INVENTION

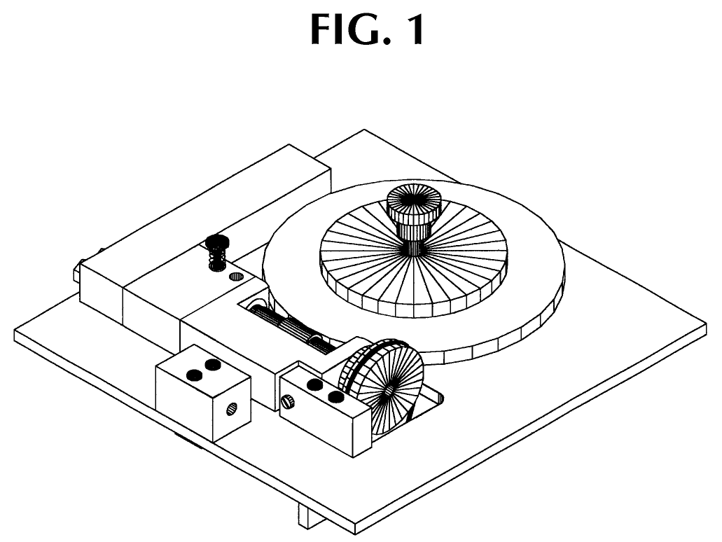

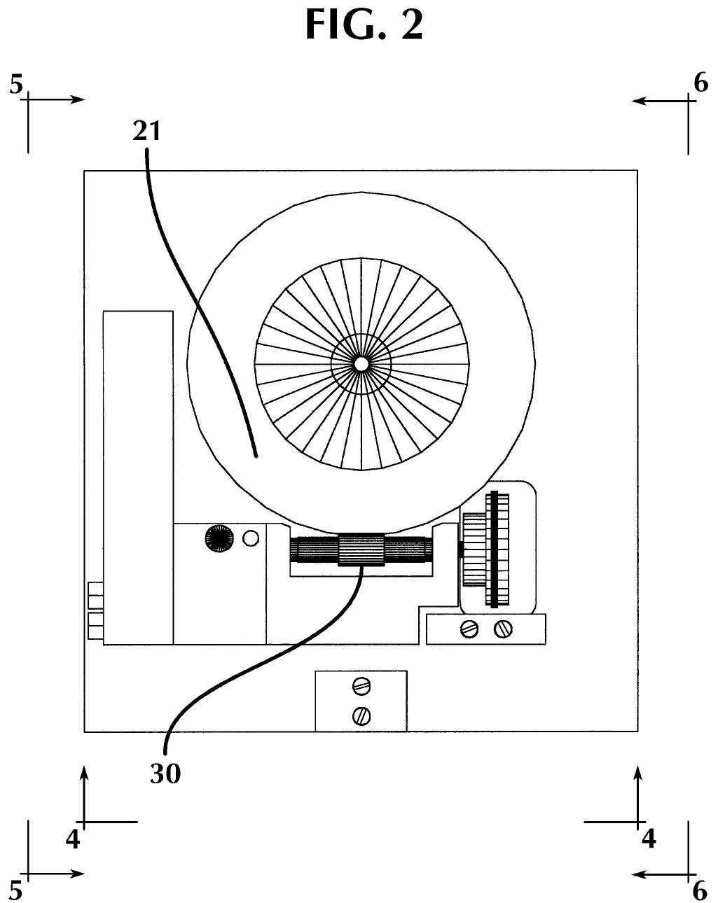

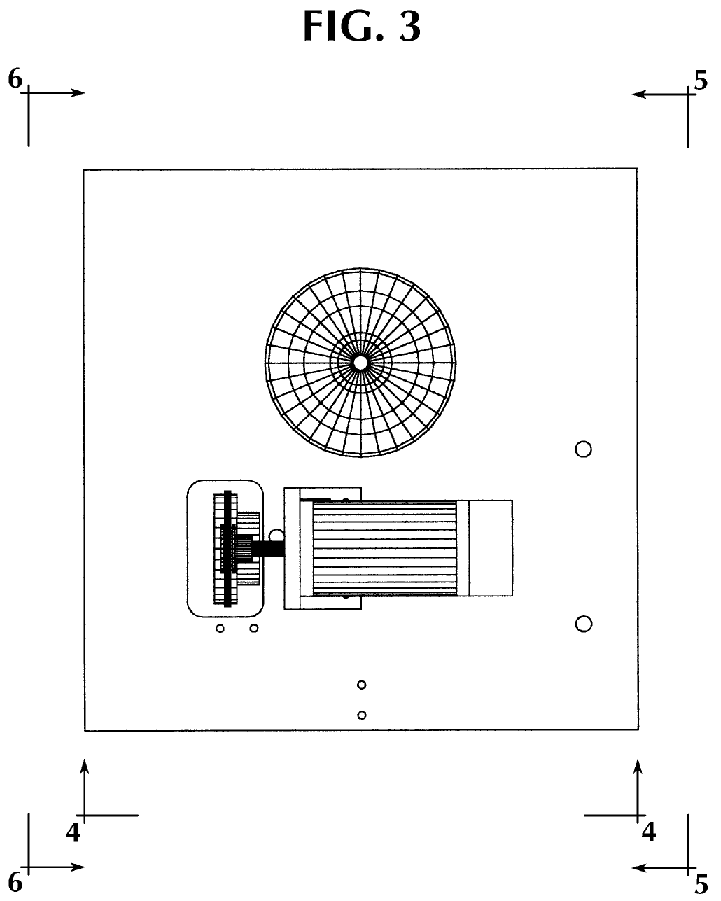

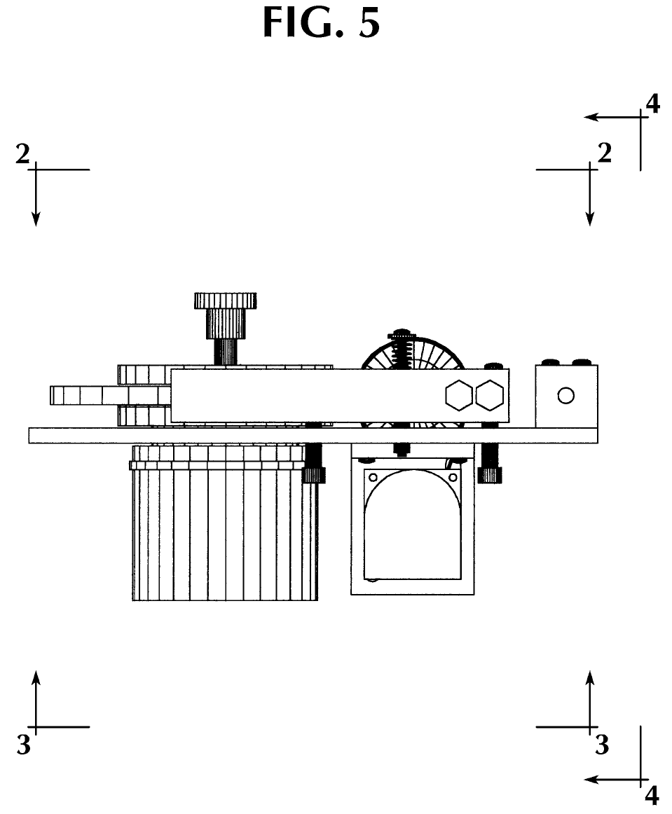

The instrument of the invention, as shown, for example, in FIG. 1, is an isometric perspective view of the worm drive system. FIGS. 2 through 6 show the instrument of the invention from various additional viewpoints. It should be understood that the examples as shown in all figures are but one of many possible implementations of the invention, said implementations being dependent upon design and space considerations as well as upon the final desired accuracy as dictated by the user of this invention. The purpose of the invention is the accurate pointing, tracking and motion about an axis of revolution, with said axis of revolution possibly consisting of intermediate axes of revolution formed by gears or other mechanisms between the invention and the final axis of revolution of the device or implement that is being controlled by the invention, it being understood that any said gears or other mechanisms forming intermediate axes of revolution are specifically excluded from this invention.

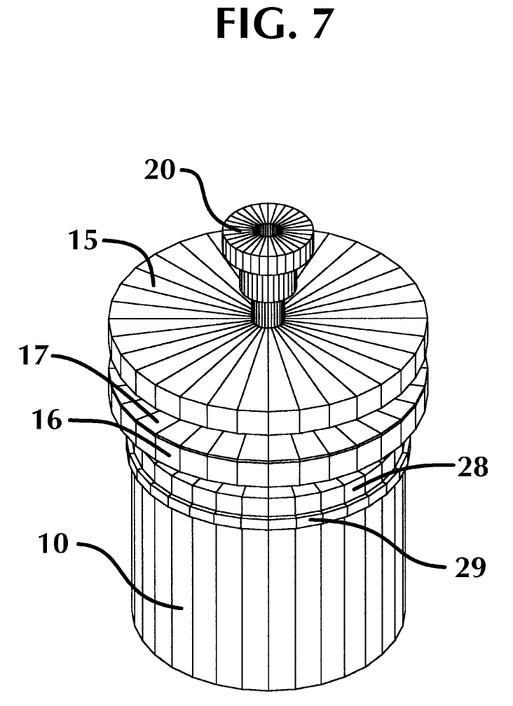

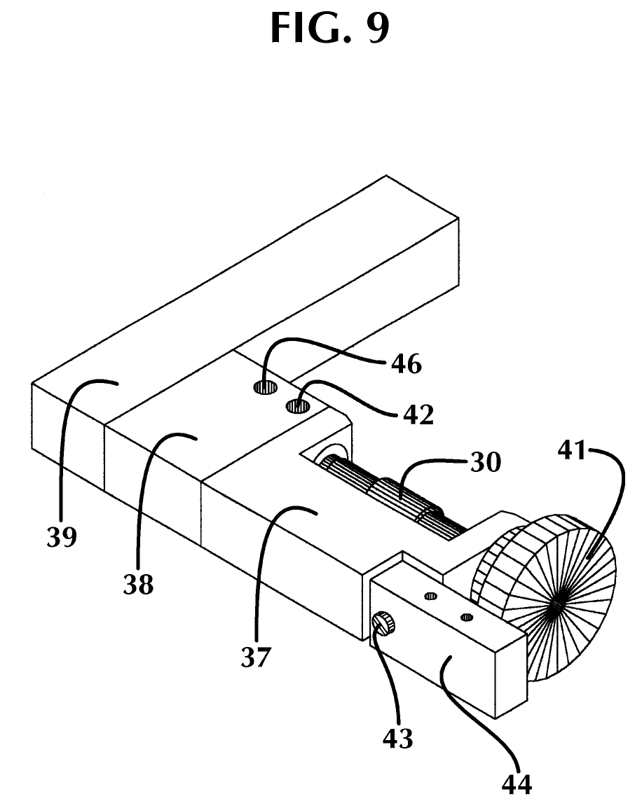

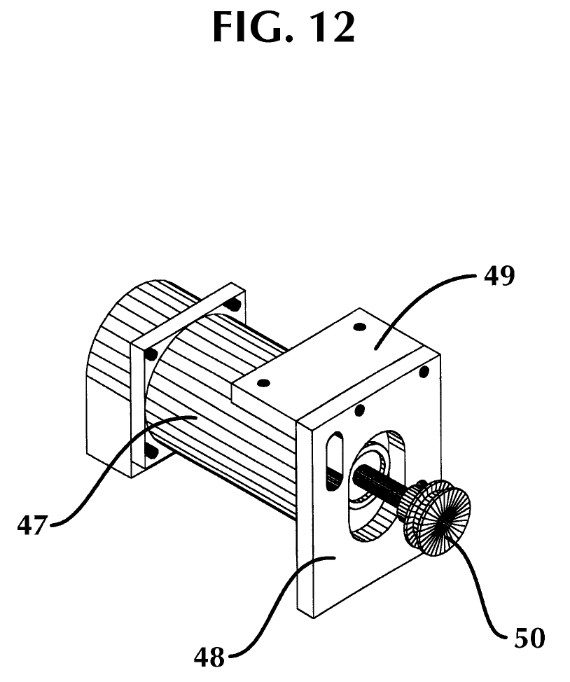

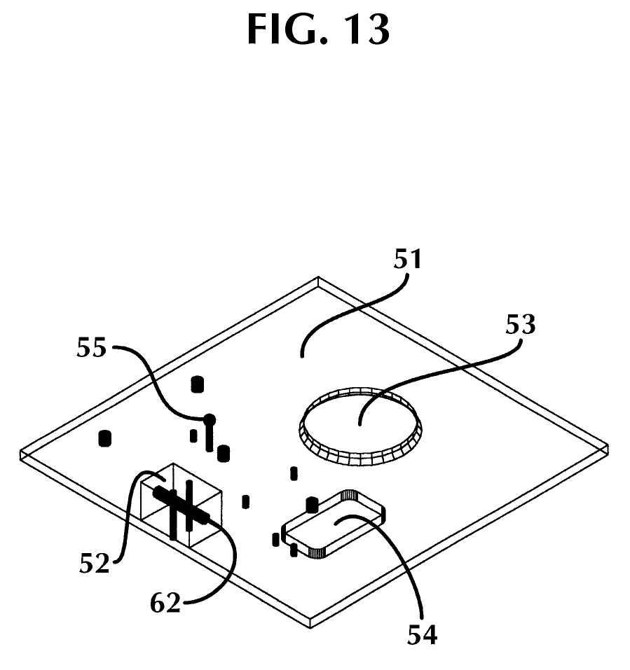

The invention consists primarily of four separate assemblies which, when combined, form the components of the invention. The components which constitute the invention are the hub assembly as shown in FIG. 7, the worm assembly as shown in FIG. 9, the motor assembly as shown in FIG. 12, and the plate assembly as shown in FIG. 13. The elements comprising each of the said assemblies and the functions of each of the said assemblies are fully described forthwith.

It is highly recommended that all elements of the four assemblies which constitute the invention should be manufactured, wherever possible, from similar materials as the worm gear element of the hub assembly component, thus preventing a slight loss of accuracy due to the differences in coefficients of expansion of through the utilization of dissimilar materials.

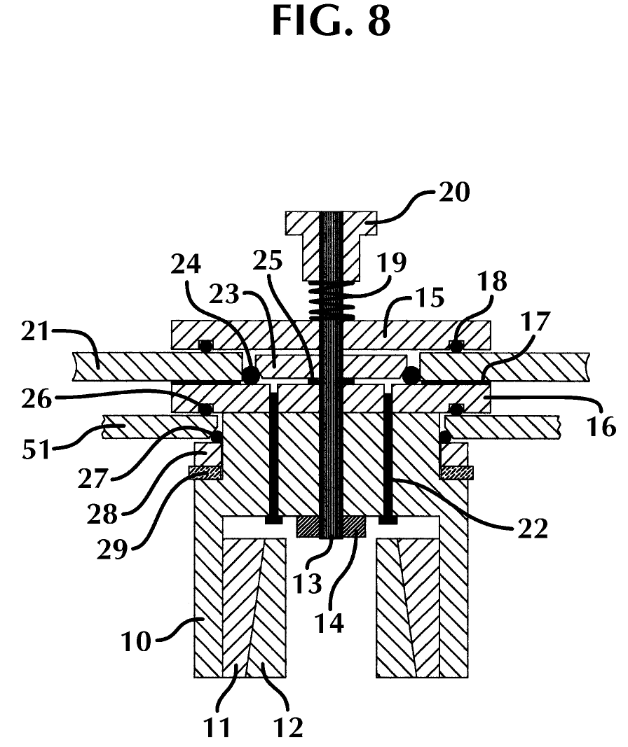

The hub assembly component of the invention is shown, for example, in FIGS. 7 and 8, and consists of several elements which serve to implement three functions. The primary function of the hub assembly is the preservation of precise alignment, in coaxial fashion, of the gear and the axis of revolution to which the invention is attached, said primary function being accomplished by the mechanical design of the hub assembly. The secondary function of the hub assembly is the impediment of damage to either the invention or to the device to which the invention is attached, said secondary function being accomplished by the provision of a clutch mechanism for the gear. Such damage could result if there was a loss of power to the motor which operates the invention or if the implement to which the invention is attached were to become obstructed, thereby impeding the implement's movement via the invention. The tertiary function of the hub assembly is the provision of a simple method for attachment to or removal from the implement to which the invention is attached.

The hub assembly consists of several elements best shown, for example, in FIG. 8. A hub 10 is provided with a machined inner bore which accepts a taper lock adapter 11 and taper lock 12. The taper lock adapter 11 and taper lock 12 are utilized to realize said tertiary function of the hub assembly component. The hub 10 is axially bored and threaded to accept a threaded rod 13 which is secured by a nut 14.

A clutch mechanism for the worm gear 21 is provided for by a top clutch plate 15, a bottom clutch plate 16, a clutch pad 17, ball bearings 18, a compression spring 19, and an adjustment knob 20. The clutch pad 17 should be bonded with an adhesive, for example, to the bottom clutch plate 16. Alternatively, an appropriate beveled surface may be provided for on the bottom clutch plate 16 with the purpose of retaining, in coaxial fashion, the clutch pad 17 relative to the axis of the threaded rod 13 and thereby the hub 10. The bottom clutch plate 16 is attached to the hub 10, for example, with several screws 22. It should be noted that both clutch plates 15 and 16 feature an axial clearance bore providing clearance between said clutch plates and the threaded rod 13. The action of the clutch mechanism is governed by either tightening or loosening the adjustment knob 20, thereby increasing or decreasing, via the compression spring 19, pressure on the top clutch plate 15 and the ball bearings 18 retained within said top clutch plate, in turn increasing or decreasing pressure between the worm gear 21 and the clutch pad 17. The ball bearings 18 serve the important function of preventing the top clutch plate 15 from possibly acting in any fashion as a clutch mechanism for worm gear 21, the action of the clutch mechanism being solely governed by the frictional contact, governed by the pressure exerted by compression spring 19, between the worm gear 21 and the clutch pad 17. Additionally, the compression spring 19 should be of suitable length and strength as to provide the necessary pressure desired by the user to achieve a sufficient range of clutch action, while minimizing differences in pressure exerted by the compression spring 19 on the top clutch plate 15 due to differences in coefficients of expansion of the various materials that may be used to fabricate this portion of the invention. Finally, it should be noted that the ball bearings 18 retained within the top clutch plate 15 are radially located at the same median radial distance as the clutch pad 17 from the axis of hub 10, thereby preventing any possibility of warpage of the worm gear 21 as a result of pressure exerted upon the worm gear 21 by said clutch mechanism.

The clutch mechanism heretofore described also includes a precision centering mechanism for the worm gear 21, said precision centering mechanism being comprised of a gear centering ring 23, ball bearings 24, and Belleville disk springs 25. This is a necessary feature of the clutch mechanism since the worm gear 21 must always be held in coaxial fashion relative to the coincident axes of the hub 10 and the threaded rod 13. The gear centering ring 23 is axially bored and threaded such that it threads onto the threaded rod 13 until the beveled edge of said gear centering ring comes into tight contact with ball bearings 24, thereby precisely centering and aligning the axis of the worm gear 21 in coaxial fashion with the axis of the hub 10. The Belleville disk springs 25 push axially against the gear centering ring 23 with sufficient force to assure that said gear centering ring is held in coaxial fashion relative to the threaded rod 13 and thereby the axis of the hub 10.

The hub assembly is attached and held concentrically within the drive plate bore 53 of the drive plate 51 of the invention by ball bearings 26 and 27, the bearing pressure ring 28 and the wave spring 29. The wave spring 29 applies pressure against the bearing pressure ring 28 and thence bearings 27, forcing the hub 10 to become concentrically indexed within the drive plate bore 53. As a result, the hub 10 is held in coaxial fashion relative to the drive plate bore 53, said hub remaining free to rotate in coaxial fashion within said drive plate bore.

The wave spring 29 should be chosen such that it provides a force that is between ten times to twenty times the maximum expected force that may be applied, at any time during the operation of the invention, about the axis of revolution of the worm gear 21, with the adjustable action of said clutch mechanism having been taken into consideration. Alternatively, the wave spring 29 may be dispensed with, and instead mating threads may be machined on the inner bore of the bearing pressure ring 28 and the adjoining outer region of hub 10, thereby allowing the bearing pressure ring to be threaded in a direction towards bearings 27, forcing the hub 10 to become concentrically indexed within the drive plate bore 53 as described above, this being a more suitable solution where stronger forces are expected to be applied about the axis of revolution of worm gear 21.

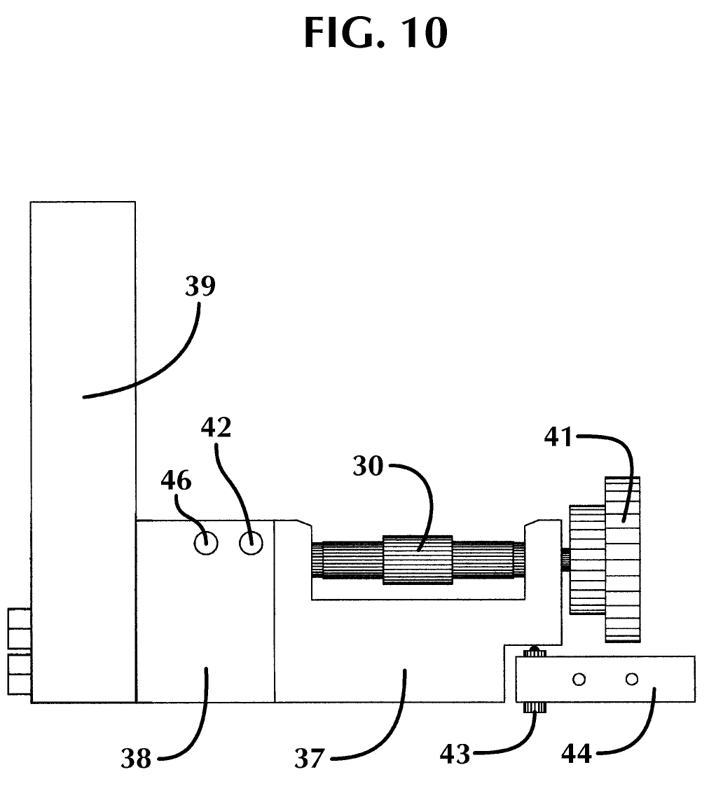

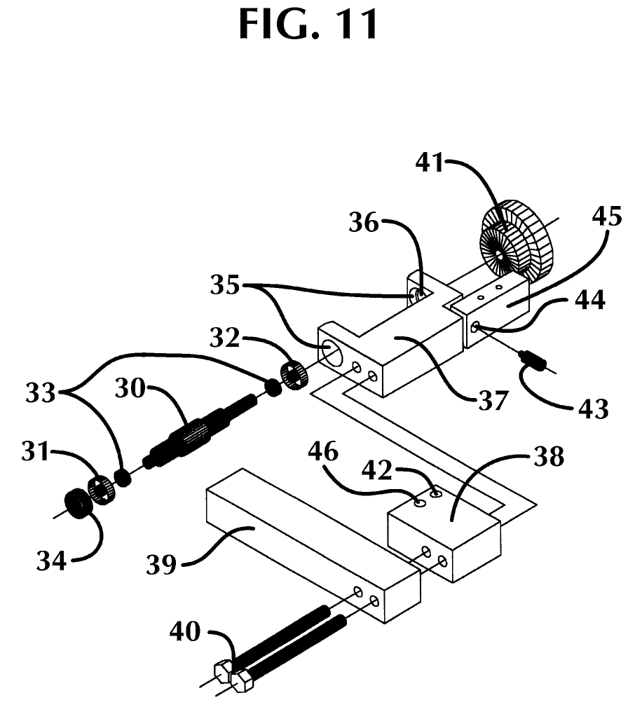

The worm assembly component of the invention is shown, for example, in FIGS. 9 and 10, and consists of several elements best shown in FIG. 11 which is an exploded view of said worm assembly. The function of the worm assembly the preservation of the alignment and engagement of the worm 30, in precise fashion as described forthwith, relative to the worm gear 21.

Precision bearings 31 and 32, being of diameter greater than the diameter of the worm 30, and bearing spacers 33 are installed on each end of said worm's integral shaft. A stack of Belleville disk springs 34, are installed at one end of said worm's integral shaft. These elements are then installed into the machined bore 35 within the worm block 37, it being noted that said worm block features a stepped bore 36 which forms a seat for the outer race of bearing 32. It should also be noted that the machined bore 35 should include the minimal clearance necessary to prevent binding of said precision bearings within said machined bore. The stack of Belleville disk springs 34 allow for differences in expansion coefficients between the different materials that may be utilized in the construction of the worm block 37, the worm 30, the precision bearings 31 and 32, and the bearing spacers 33, while maintaining a relatively constant preload upon said precision bearings which support said worm. The maintenance of this relatively constant preload upon the precision bearings 31 and 32 is important to prevent excessive wear within said precision bearings, to maintain a relatively constant value for the minimum required force that is necessary to rotate said worm, and to remove any internal play within said precision bearings. The pivot block 38 and balance block 39 are then attached, for example, with a pair of machine screws 40 installed through appropriate clearance bores in the balance block 39 and the pivot block 38, thence into appropriate threaded bores located within the worm block 37, thereby mating all said blocks together as a unit and also compressing the stack of Belleville disk springs 34 to preload the precision bearings 31 and 32. A geared worm pulley 41 is then attached to the exposed end of the integral shaft of the worm 30. The heretofore described elements of the worm assembly, now being assembled and mated together, shall hereinafter be referred to as the worm unit.

The pivot block 38 features a precision bore 42, the axis of said precision bore intersecting a line tangent to the point of contact between the worm 30 and the worm gear 21 and being perpendicular to the plane defined by axis of the worm 30 and the point of contact between the worm 30 and the worm gear 21. The balance block 39 is designed with appropriate dimensions and mass such the center of gravity of said worm unit is coincident with axis of the precision bore 42 and is located on a line tangent to the point of contact between the worm 30 and the worm gear 21.

The center of gravity of the worm unit, being located on the axis of the precision bore 42 by means hitherto described, defines the pivot point of said worm unit. The location of said pivot point is important to assure that the worm 30 maintains a constant pressure of engagement toward the worm gear 21 whether said worm is turning in a clockwise or counter clockwise direction, thus assuring that any wear on the teeth of the worm gear 21, which occurs over time through normal operation of the invention, remains identical on both sides of said teeth, thereby allowing the worm 30 to continuously and accurately lap into the worm gear 21. The continuous and accurate lapping of the worm 30 into the worm gear 21 will, during operation of the invention over extended periods of time, actually improve the accuracy of the invention. Said worm unit is engaged into the worm gear 21 by a spring plunger 43 installed through the tapped bore 44 located in the plunger block 45. The axis of the tapped bore 44 is perpendicular to the axis of the worm 32 and ideally is located in the plane defined by the axis of worm 30 and the point of contact between the worm 30 and the worm gear 21.

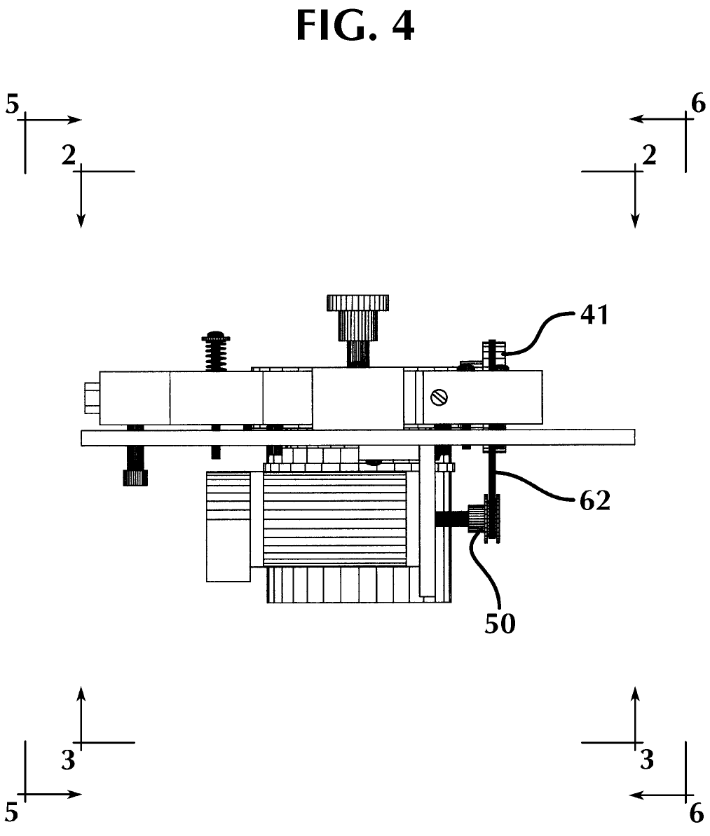

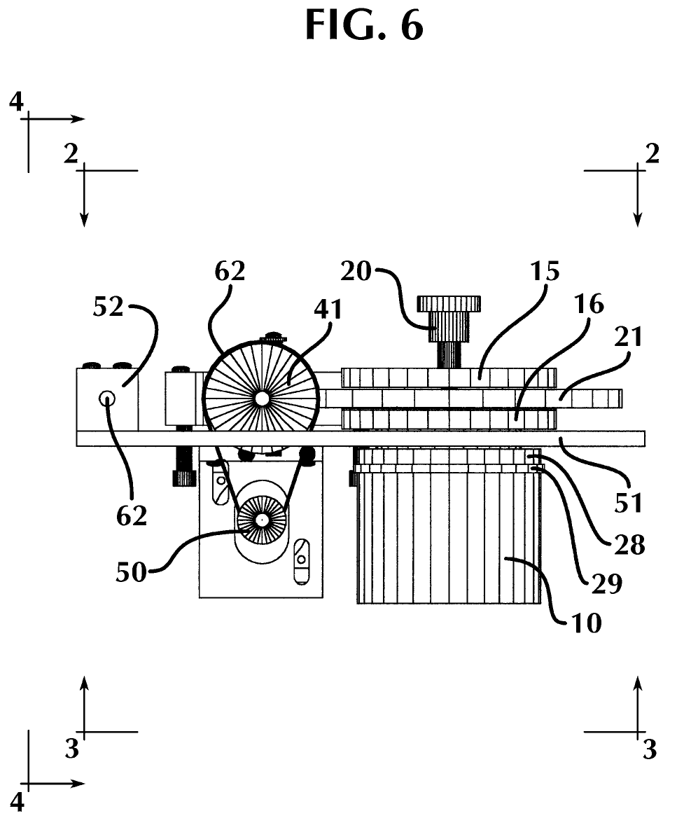

The motor assembly component of the invention is shown, for example, in FIG. 12. The motor assembly serves two functions. The primary function of the motor assembly is the prevention of vibrations, produced by the motor which powers the invention, from affecting said worm unit. Such vibrations could result in premature wear to the worm 30 and the worm gear 21. The secondary function of the motor assembly is the prevention of the motor from applying torque to said worm unit, which would disturb the alignment of the worm 30 relative to the worm gear 21, were the motor directly coupled to the worm unit and to the integral shaft of worm 30. Both said functions of the motor assembly are accomplished by isolating the motor element, described forthwith, from said worm unit. The motor assembly consists several elements. A motor 47 which is attached to a motor bracket comprised of bracket plates 48 and 49, said motor bracket providing a simple and stable framework for attachment of said motor to the drive plate 51 of the plate assembly. A geared motor pulley 50 is attached to the shaft of motor 47. A belt 62, best shown in FIGS. 4 and 6, is coupled to the geared motor pulley 50 and to the geared worm pulley 41, providing a mechanism for the motor 47 to turn about an axis of revolution the geared worm pulley 41 and therefore worm 30. The bracket plate 48 should include, if necessary, appropriate machined slots for the mounting screws of the motor 47 to allow adjustment of the tension applied to the belt 62.

The plate assembly component of the invention is shown, for example, in FIG. 13. The plate assembly serves two functions. The first function of the plate assembly component is to provide a stable mechanism for holding the hub assembly component in precise fashion relative to the worm assembly component. The second function of the plate assembly component is to provide a stable mechanism for holding the motor assembly component in precise fashion relative to the worm assembly component.

The plate assembly component consists of several elements including a drive plate 51, a load block 52 attached to said drive plate via appropriate screws, a hub bore 53, a clearance slot 54 for the geared worm pulley 41 and the belt 62, a tooling ball 55, plus several machined or tapped bores providing for the adjustment of the worm assembly component and the attachment of the hub assembly component, the worm assembly component, and the drive assembly component.

The hub assembly component is attached to the drive plate 51 byway of the hub bore 53. It should be readily apparent, upon examination of FIG. 8, that the hub assembly component is free to rotate in coaxial fashion within the hub bore 53 of the drive plate 51, and that various elements of the hub assembly component must first be installed in and around the hub bore 53, thereby securing the core elements of said hub assembly component to said drive plate, before the remaining elements of the hub assembly component are installed to complete the construction of said hub assembly component.

The worm unit of the worm assembly component is attached to top of the drive plate 51 by placing the precision bore 42 within the pivot block 37 of said worm unit upon the tooling ball 55. The worm unit is then secured to the drive plate 51 by installing a screw 56 and compression spring 57 through a clearance bore 46 located in the pivot block 37, it being understood that the spring 57 compresses upon the upper surface of the worm unit to retain said worm unit upon the drive plate 51. As a result, the worm unit, while retained upon the drive plate 51 is free to pivot about the tooling ball 55. The plunger block 45 of the worm assembly component is then attached with screws 58 to the drive plate 51, and the spring plunger 43 is installed through bore 44 of said plunger block to engage the worm 30 into the worm gear 21. The worm 30 of the worm unit is aligned to the worm gear 21 by adjusting round head screws 59, thereby allowing for precise adjustment of the throat height and tangent angle of the worm 30 relative to the worm gear 21. The nylon thumb screws 60 are then adjusted such that the bottom plane of the worm unit is parallel to the top plane of the drive plate 51, said nylon thumb screws then being locked in place, for example, with lock nuts. The worm unit has now been secured to the drive plate 51, the worm 30 has been properly aligned and engaged to the worm gear 21, said worm unit remaining free to pivot about the tooling ball 55 such that, due to the action of the spring plunger 43, the worm 30 remains fully engaged to the worm gear 21 at all times and at all ambient temperatures, regardless of differences in coefficients of expansion of the various materials that may have been used to construct the invention.

The motor assembly component is attached to the bottom of the drive plate 51, it being noted that the point of attachment is specifically chosen such that the plane defined by the axes of the shaft of the motor 47 and the worm 30 is perpendicular to the plane defined by the axis of the worm 30 and the point of contact between the worm 30 and the worm gear 21. A belt 62 is then installed to couple the geared motor pulley 50 to the geared worm pulley 41, the motor 47 then being adjusted to achieve the desired tension of said belt. It should be noted that said point of attachment is specifically chosen to prevent belt 62, when tensioned, from affecting either the engagement or alignment of the worm 30 relative to the worm gear 21.

The fully assembled invention is then attached, by way of the taper lock 12, to the axis of revolution of the implement that the invention is to control. It should be noted that, at this point, that the plate assembly component, including the attached worm assembly component and attached motor assembly component, is free to rotate about the axis of the hub assembly component, this freedom of rotation being limited solely by the action of said clutch mechanism. One end of a threaded rod (not shown for clarity) is then installed through the bore 62 of the load block 52, said bore being parallel to the axis of the worm 30. Said threaded rod is then secured to the load block 52, for example, with lock nuts. It should be noted that the bore 62 within the load block 52 ideally should be located in the plane defined by the axis of the worm 30 and the point of contact between the worm 30 and the worm gear 21. The other end of said threaded rod is then attached to the implement that the invention is to control, by whatever fashion the user of this invention decides to devise. In this manner, the plate, worm and motor assembly components are precisely held by said threaded rod in a static position relative to the implement and the implement's axis of revolution, thereby allowing the axial rotation of the worm, via action of the motor, to precisely rotate worm gear 21 and therefore the hub assembly component, moving the implement about the implement's axis of revolution.

It will be appreciated that while a particular embodiment of the invention has been shown and described, modifications may be made, and it is intended in the claims to cover all modifications which come within the true spirit and scope of the invention.

1. A worm drive system providing for precision pointing, motion and tracking about an axis of revolution various types of implements including astronomical telescopes and LIDAR systems, said worm drive system being comprised of a plate assembly supporting in precise method a hub assembly which includes a worm gear and a clutch mechanism, a worm assembly which features a pivot point for said worm assembly and includes a worm supported by precision bearings, and a motor assembly which includes a motor.

2. The hub assembly defined in claim 1, featuring said clutch mechanism which includes design means for maintenance of precise coaxial alignment of said worm gear relative to the axis of said hub assembly, includes means for adjustment of the action of said clutch mechanism, and includes design means of said clutch mechanism to prevent warpage of said worm gear during said adjustment of the action of said clutch mechanism.

3. The hub assembly defined in claim 1, featuring design means for easy attachment to and removal from the implement to which said hub assembly is attached.

4. The worm assembly defined in claim 1, featuring design means for maintaining a relatively constant preload of said precision bearings which support said worm, thereby preventing excessive wear within said precision bearings or development of internal play within said precision bearings due to said wear.

5. The worm assembly defined in claim 1, said pivot point located on a line tangent to the point of contact between said worm and the worm gear defined in claim 1, thereby preventing uneven wear from occurring to the teeth said worm gear, said worm gear possibly being supported by means other than that described in claim 1.

6. The worm assembly defined in claims 1 and 5, featuring means of maintaining constant engagement of said worm to said worm gear, via said pivot point, whether said worm rotates in clockwise or counterclockwise fashion, thereby allowing said worm to continuously lap into said worm gear during use and improving the precision of the invention over time.

7. The worm assembly defined in claim 5, featuring design means of balancing said worm assembly about said pivot point, thereby preventing torque produced by gravity or acceleration and movement of the implement to which said worm assembly is attached, from affecting the alignment of said worm to said worm gear.

8. The motor assembly defined in claim 1, featuring design means of attachment to the plate assembly defined in claim 1, such that the axis of said motor and the axis of said worm are located in a plane that is perpendicular to the axis of said worm and said point of contact defined in claim 5, said motor being coupled to said worm by a tensioned belt and two pulleys, such that the tensioned belt does not affect the alignment of said worm relative to said worm gear defined in claim 5.

9. The motor assembly defined in claim 1, featuring design means of preventing said motor from affecting the alignment of said worm relative to said worm gear.

10. The plate assembly defined in claim 1, featuring design means for precise adjustment of the worm assembly defined in claim 6 relative to the worm gear defined in claim 5.

11. The plate assembly defined in claim 1, featuring design means of fixing the position of said plate assembly relative to the implement to which said plate assembly is attached, thereby allowing the axial rotation of the worm defined in claim 1, via action of the motor defined in claim 1, to precisely rotate the hub assembly defined in claim 1 and therefore the implement about the implement's axis of revolution.
